(19) United States
(12) Patent Application Publication
(10) Pub. No.: US 2015/0031427 A1
(43) Pub. Date: Jan. 29, 2015

(54) Method, System And Portable Digital Media For Processing An Interactive Game Of Chance

(71) Applicants: Michael Paul Platzer, Southport (AU); Michael Matthew Sydenham, Southport (AU)

(72) Inventors: Michael Paul Platzer, Southport (AU); Michael Matthew Sydenham, Southport (AU)

(73) Assignee: Interactive Outcomes Pty Ltd, Darwin (AU)

(21) Appl. No.: 14/127,176

(22) PCT Filed: Jun. 21, 2011
(86) PCT No.: PCT/AU2011/000758

§ 371 Date: Aug. 15, 2014

(51) Int. Cl. G07F 17/32; G07F 17/34

(52) U.S. Cl. CPC G07F 17/3211; G07F 17/3225; G07F 17/329; G07F 17/34; G07F 17/3293
USPC 463/11; 463/16; 463/17; 463/20

(57) ABSTRACT

A method, system and portable digital media for processing an interactive game of chance enables an alternative gambling experience. The method includes coupling a portable digital media, including the interactive game of chance, with a consumer device; viewing visual components of the interactive game of chance, wherein the visual components are used to define a predetermined outcome of the interactive game of chance; interacting with the visual components through the consumer device; and viewing the predetermined outcome of the interactive game of chance.

### FIELD OF THE INVENTION

The present invention relates to gambling. In particular, although not exclusively, the invention relates to remote gambling.

### BACKGROUND TO THE INVENTION

There is a substantial segment of the world population that enjoys wagering responsibly on various games of chance for entertainment purposes. There are a considerable number of wagering options including visiting purpose-built facilities (such as pubs, clubs, casinos and bingo halls), and using online wagering sites through a personal computer connected to the internet.

There are however several disadvantages of the wagering options mentioned above, especially for those who wish to wager on games of chance from home. For example, a computer and an internet connection of sufficient capability are needed. Some gamblers may only have a standalone computer without an internet connection, or may be unable or unwilling to connect to the Internet. Additionally, local laws or regulations may prohibit a person from participating in online wagering. A further disadvantage is that the gambler may not have a level of comfort to access and navigate various web sites to perform any necessary software installation, player registration, and funds management to enable playing online games with confidence.

A further aspect of online wagering relates to payment, or a depositing of funds to enable game play. This is usually performed online at the wagering web site and is often facilitated by a third party service. A disadvantage of this system is that a significant level of security awareness and a familiarity with performing online transactions is required. Additionally, a credit card is generally required as cash cannot be used.

Another disadvantage with online wagering is that all wagering goes through one or more wagering servers, enabling others to track a gambler's behaviour in great detail.

A disadvantage with credit card based wagering services is that there is little to no control over a gambler's expenditure. When credit cards are used as a purchasing medium online, for example, problems with greater than planned expenditure and the problems related therewith typically increase.

Lottery tickets are a popular form of gambling that may be enjoyed at home, without the need for a computer or internet. A disadvantage, however, is that lottery ticket results are revealed at a set time which cannot be controlled by the user and are delivered in a strictly limited and predefined format.

Scratch cards are another popular form of gambling where a user may gamble at home, or otherwise, at a time of his or her choice. Scratch cards have the disadvantage of being “static” as they are printed on a card, as opposed to the lights, music, animation and/or video which may be present online and at purpose-built gambling facilities.

Recordings of gambling experiences, e.g. recordings of slot machines in action, are available for viewing at home, for example on a DVD player. Such recordings lack however an interactive component which is present when actually gambling, as one is simply viewing a recording of a gambling session.

Some or all of the abovementioned disadvantages may present barriers that can frustrate a player who wants to experience a genuine and fair wagering experience in the comfort of their home, at a time of their choosing and with safeguards on their wagering expenditure.

There is therefore a need to overcome or alleviate many of the above discussed disadvantages associated with gambling of the prior art.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

According to one aspect, the invention resides in a method of processing an interactive game of chance, including:

coupling a portable digital media, including said interactive game of chance, with a consumer device;

viewing visual components of said interactive game of chance, wherein said visual components are used to define a predetermined outcome of said interactive game of chance;

interacting with said visual components through said consumer device; and

viewing said predetermined outcome of said interactive game of chance.

Preferably, said method further includes redeeming a prize based upon said predetermined outcome.

Preferably, said interactive game of chance includes a virtual scratch card, said visual components include a plurality of scratch panels, and interacting with said visual components includes simulating scratching said plurality of scratch panels.

Preferably, said interactive game of chance includes a virtual slot machine, said visual components include reels of said virtual slot machine, and said step of interacting includes at least one of selecting a bet size, selecting a payline and initiating spinning of said reels.

Preferably, said interactive game of chance includes a virtual card game, said visual components include cards of said virtual card game, and said step of interacting includes at least one of selecting a bet size, and selecting cards to be held, discarded or drawn.

Preferably, said interactive game of chance includes a starting point including said visual components of said interactive game, and an end point including said predetermined outcome, wherein said interactive game comprises traversing one pathway of a plurality of pathways between said starting point and said end point, said one pathway dependent on said step of interacting with said visual components.

Preferably, said one pathway between said starting point and said end point is skill dependent.

Preferably, said method further includes selecting said interactive game from a plurality of interactive games, wherein said plurality of interactive games all include said predetermined outcome.

According to a further aspect, the invention resides in a portable digital media containing digital instructions, executable by a consumer device, for:

displaying visual components of an interactive game of chance, wherein said visual components are used to define an outcome of said interactive game of chance;

processing an interaction between a user and said visual components through said consumer device; and

displaying at least one predetermined outcome of said interactive game of chance, wherein said predetermined outcome is independent of said interaction.

Preferably, said predetermined outcome is associated with a prize.

Preferably, said portable digital media further includes a tamper resistant packaging.

Preferably, said predetermined outcome is written on an outer surface of said portable media.

Preferably, said predetermined outcome written on said outer surface is coded.

Preferably, said predetermined outcome written on said outer surface is not visible through said tamper resistant packaging.

Preferably, said predetermined outcome is linked at purchase to at least one of a person, a credit card, and an account.

Preferably, said portable digital media comprises a Digital Versatile Disc (DVD) and said digital instructions are recorded in video mode.

Preferably, said digital instructions comprise a virtual-machine menu and a plurality of video titles, wherein said interaction comprises selecting a component of said virtual-machine menu, and said digital instructions result in a display of a video title of said plurality of video titles based upon said component that was selected.

Preferably, said digital instructions comprise a first level virtual-machine menu, a plurality of second level virtual-machine menus, a plurality of first level video titles, and a plurality of second level video titles, wherein said interaction comprises selecting a first component of said first level virtual-machine menu and selecting a second component of a second level virtual-machine menu of said plurality of second level virtual-machine menus, wherein said digital instructions result in displaying a video of said plurality of first level video titles and said second level virtual-machine menu based upon said first component that was selected and displaying a video of said plurality of second level video titles based upon said second component that was selected.

Preferably, said portable digital media consists of one of the following: a USB memory, a DVD, a solid state memory device, a flash memory device, a memory stick, a smart media card, a secure digital card.

Preferably, digital instructions comprise a computer program.

According to a further aspect, the invention resides in a system for generating a portable digital media including an interactive game of chance, including:

an outcome generator, which generates an outcome for an interactive game of chance;

an interactive game of chance resource including visual components;

a game generator, which generates said interactive game of chance from said interactive game of chance resource and said outcome, wherein said outcome is displayed using said visual component of said interactive game of chance resource; and

a game recorder, which records said interactive game of chance to a portable digital media.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1A shows a screen shot of an interactive game of chance in the form of a scratch card according to an embodiment of the present invention;

FIG. 1B shows another screen shot of the scratch card of FIG. 1A where a scratch panel has been scratched;

FIG. 1C shows yet another screen shot the scratch card of FIG. 1A where all scratch panels have been scratched and a winning outcome is displayed;

FIG. 1D shows yet another screen shot the scratch card of FIG. 1A where all scratch panels have been scratched and a losing outcome is displayed;

FIG. 2 shows a flow diagram of the processing of an interactive game by a consumer device;

FIG. 3 shows screen shot of an interactive game of chance in the form of a slot machine according to an embodiment of the present invention;

FIG. 4 shows a flow diagram of the processing of an interactive game in the form of a scratch card on a DVD, by a DVD player;

FIG. 5 shows a DVD structure of a plurality of interactive games of chance stored on a single DVD;

FIG. 6 shows a portable digital media including an interactive game of chance according to an embodiment of the present invention;

FIG. 7 shows a digital media, including a tamper resistant packaging, according to an embodiment of the present invention;

FIG. 8 illustrates a system for generating digital media including a game of chance according to an embodiment of the present invention; and

FIG. 9 shows a flow diagram of a method of processing an interactive game of chance.

Those skilled in the art will appreciate that minor deviations from the layout of components as illustrated in the drawings will not detract from the proper functioning of the disclosed embodiments of the present invention.

### DETAILED DESCRIPTION OF THE INVENTION

Embodiments of the present invention comprise gambling systems, methods and media. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

In one aspect, the invention resides in a method for remote gambling. The method includes coupling a portable digital media, including an interactive game of chance, with a consumer device; viewing visual components of said interactive game of chance, wherein said visual components are used to define a predetermined outcome of said interactive game of chance: interacting with said visual components through said consumer device; and viewing said predetermined outcome of said interactive game of chance.

Advantages of some embodiments of the present invention include the ability to gamble at a time and place of choice, without needing a computer with an internet connection of a particular capability, without needing to register an identification, without needing a credit card, and with the privacy of not allowing others to track gambling behaviour in great detail. Further embodiments of the present invention include an interactive component that gives the user the feeling and excitement associated with gambling in real time and determining or changing a final outcome. Additionally, the portable digital media enables an enhanced multimedia experience including audio and visual effects, and an ability to have a long gaming session in a small format.

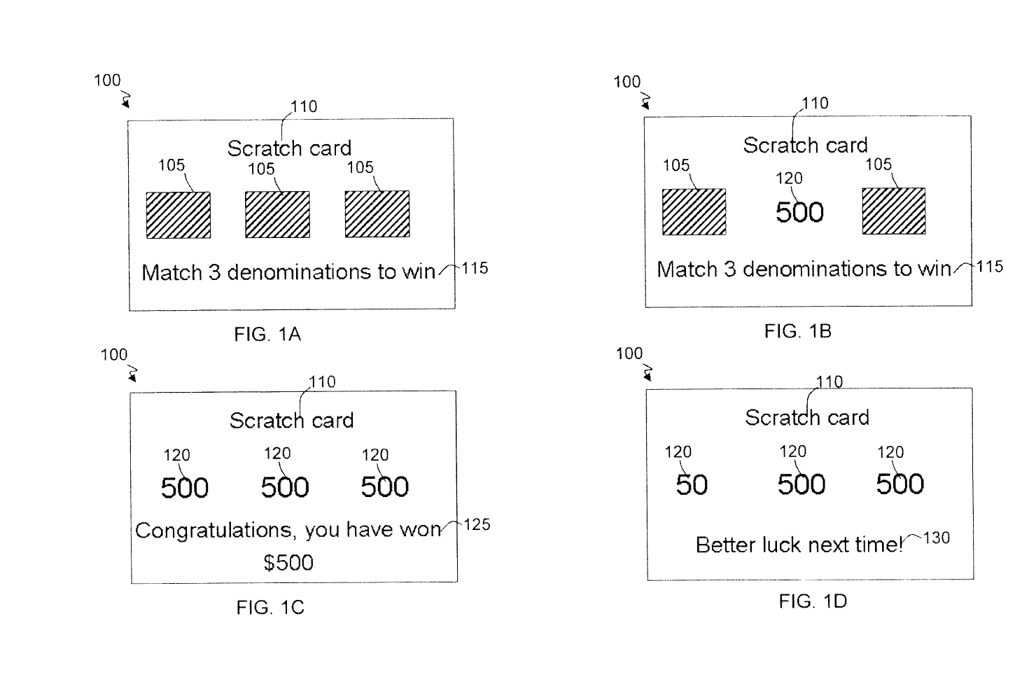

FIG. 1A shows a screen shot of an interactive game of chance in the form of a scratch card 100 according to an embodiment of the present invention. The scratch card 100 includes a plurality of visual components including scratch panels 105, a brand identifier 110 and instructions 115. The scratch panels are used to define a predetermined outcome of the interactive game of chance. The scratch panels are ‘scratched’ through an electronic interaction revealing the predetermined outcome.

As is understood by a person skilled in the art, several other visual components may be present in a scratch card 100, and neither the brand identifier 110 nor instructions 115 need be present on the scratch card 100. Furthermore, as is understood by one skilled in the art, any number of scratch panels 105 may be present on the scratch card 100, as may any number of prize panels or prize-multiplier panels.

FIG. 1B shows another screen shot of the scratch card 100 where a scratch panel 105 has been scratched, i.e. a user has interacted with the scratch panel 105 by scratching it. An outcome component 120 of the scratch card 100 is revealed. As is understood by one skilled in the art, no actual scratching is performed, but scratching is simulated. Forms of simulated scratching include simply revealing an outcome component 120, and removing the scratch panel 105 in a manner such that the outcome component 120 is revealed in a gradual manner. Alternatively, flashes or other animations may be used to simulate scratching that may typically not be associated with real scratching.

FIG. 1C shows another screen shot of the scratch card 100 where all scratch panels 105 have been ‘scratched’ and a winning outcome is displayed. The winning outcome is displayed both as a combination of the outcome components 120, and as a further winning message 125. As is understood by one skilled in the art, the winning outcome need only be displayed in a single form.

The outcome component 120 and/or winning message 125 is associated with a prize. For example, the outcome component 120 may indicate a monetary value that is redeemable from an agent, or from where the scratch card 100 was purchased. Other examples of prizes include further games of chance, material prizes or any other type of reward or prize.

FIG. 1D shows another screen shot of the scratch card 100 where all scratch panels 105 have been ‘scratched’ and a losing outcome is displayed. The losing outcome is displayed both as a combination of the outcome components 120, and as a further losing message 130. As is understood by one skilled in the art, the losing outcome need only be displayed in a single form.

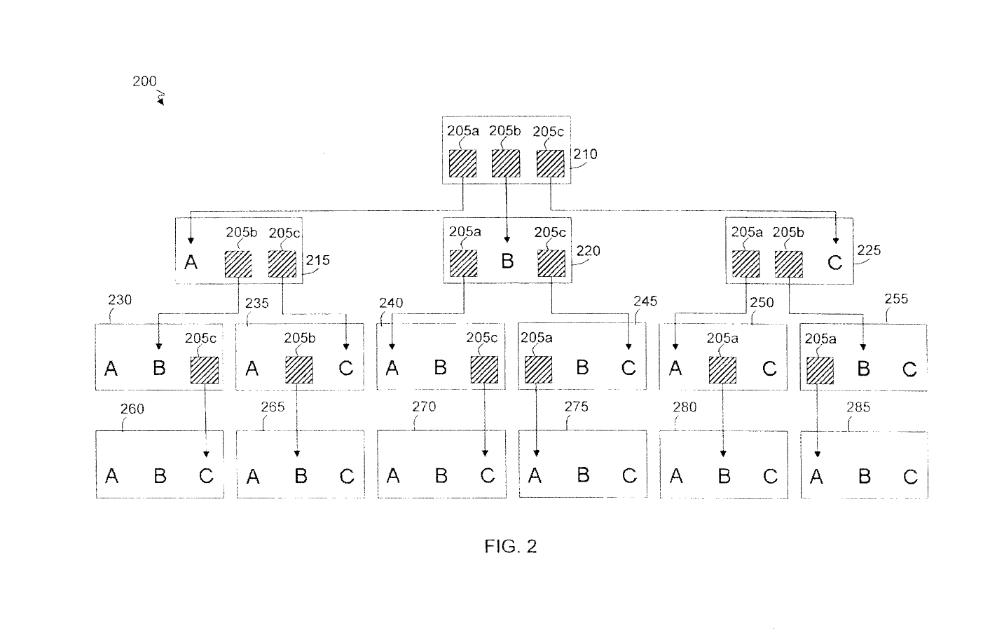

FIG. 2 shows a flow diagram 200 of the processing of an interactive game by a consumer device. The consumer device may be in the form of a DVD player with a remote control, or a personal computer with a computer input, for example. For the sake of clarity, the embodiment described herein is described in the context of the DVD player with the remote control, but as is understood by one skilled in the art the flow could easily be adapted to suit other device types.

In use, a user couples a portable digital media, in the form of a DVD, with a consumer device, in the form of a DVD player. Visual components of the scratch card are displayed on a screen of the device, or a screen connected to the device. The only visual components shown in FIG. 2 are scratch panels 205a, 205b, 205c, but as is understood by a person skilled in the art other visual components may be present. Initially all scratch panels 205a, 205b, 205c are shown to be unscratched as shown in state 210. A user interaction between the user and the scratch panels 205a, 205b, 205c may occur through a remote control of the DVD player. The user interacts with the scratch panels 205a, 205b, 205c by selecting a scratch panel 205a, 205b, 205c to be scratched, for example by using navigation buttons and an OK/ENTER button on the remote control. From state 210, the user may choose to scratch the scratch panel 205a, 205b or 205c which results in a transfer to state 215, 220, or 225 respectively.

From state 215, the user may choose to scratch the scratch panel 205b or 205c which results in a transfer to state 230, or 235 respectively. From state 220, the user may choose to scratch the scratch panel 205a or 205c which results in a transfer to state 240, or 245 respectively. From state 225, the user may choose to scratch the scratch panel 205a or 205b which results in a transfer to state 250, or 255 respectively.

At states 230, 235, 240, 245, 250 and 255, only a single scratch panel 205a, 205b, 205c is remaining. Upon scratching the remaining scratch panel 205a, 205b, 205c, the state is transferred from state 230, 235, 240, 245, 250 or 255 to state 260, 265, 270, 275, 280 or 285 respectively.

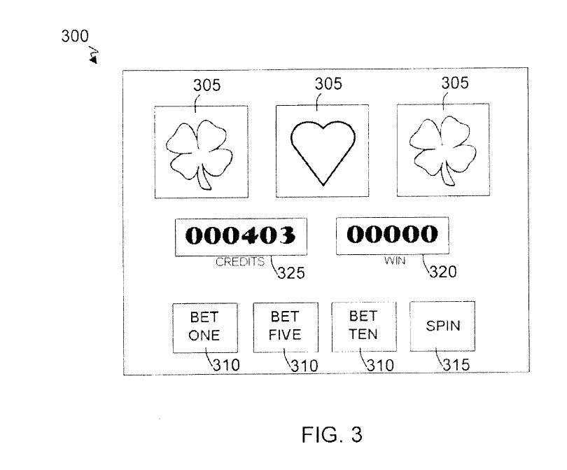

FIG. 3 shows screen shot of an interactive game of chance in the form of a slot machine 300 according to an embodiment of the present invention. The slot machine 300 includes a plurality of visual components including reels 305, bet size selection buttons 310, a spin button 315, an outcome panel 320 and a credits panel 325.

A gaming session may include playing the slot machine 300 multiple times. The gaming session may include a predetermined amount of slot machine plays, or a variable amount of slot machine plays selectable by a user.

A bet size is selected using the bet size selection buttons 310. In this embodiment, one, five or ten credits may be chosen, but as is understood by a person skilled in the art, any number of bet selection buttons 310, having any values, may be used. The user may be given a predetermined amount of credits, and the variable amount of slot machine plays is determined by the selected bet size. For example, a user betting one credit per game will get five times as many plays as a user betting five credits per game.

As the outcome is predetermined, the choice of bet size does not influence a final outcome of the slot machine 300. An outcome may be determined per slot machine play, i.e. the outcome is predetermined for each game played of a gaming session which also results in the final outcome being predetermined. Alternatively, only the final outcome is predetermined. In this case, to achieve a predetermined final outcome, a large win in an early game may be offset by a series of losses in later games.

The outcome, shown in FIG. 3 as a losing outcome, is displayed both as a combination of the reels 305, and as a win panel 320. As is understood by a person skilled in the art. the outcome need only be displayed in a single form.

The credits panel 325 displays a total number of credits. The total number of credits may be used to show accumulated winnings, credits remaining for play, or any other state of credits spanning over the slot machine plays.

As is understood by a person skilled in the art, the interactive game of chance could similarly include a virtual card game such as poker or blackjack. The visual components could include cards of the virtual card game, and the step of interacting could includes selecting a bet size, selecting cards to be held, discarded or drawn, for example. Similarly, the interactive game of chance includes other games, such as bingo, but can also include games which traditionally are not associated with gambling or lotteries.

The interactive game of chance may include a skill component, i.e. a level of skill of the user may determine a path to the predetermined outcome. For example, a skilled user may be able to play a game for longer than an unskilled user. Alternatively, a skilled user may be presented with a more challenging game than a less skilled user. For example, in black jack, the dealer may have better hands when playing against a skilled player than when playing against a less skilled player.

Although the outcome is predetermined, a skill level of a user can be determined and communicated by the game. This may be performed by logging the pathways taken and by communicating a skill level to the player in the form of a ‘code’. This code may be used to restart a future game at a similar skill level, to keep a record of the player's aggregate skill level over several games, and/or to give the player a benefit separate to the outcome.

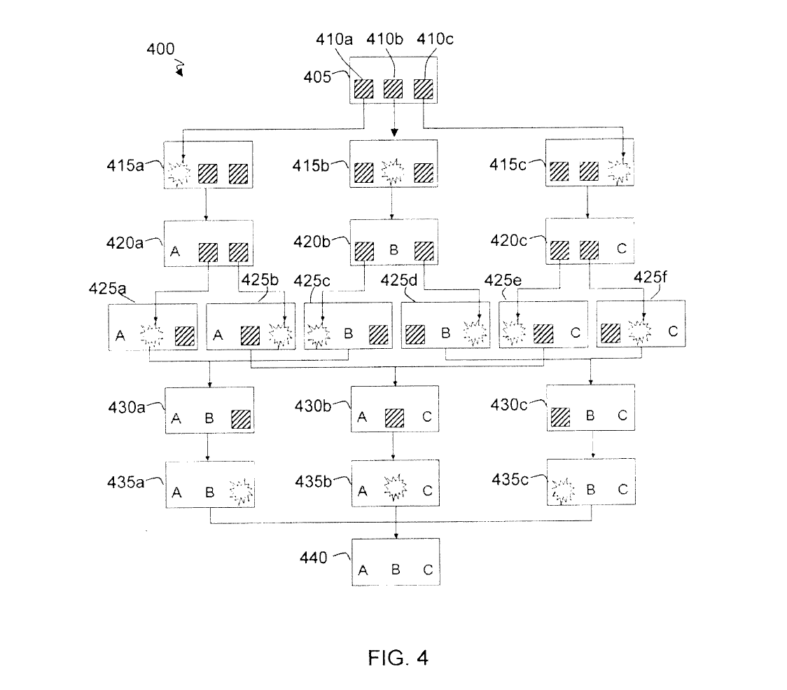

FIG. 4 shows a flow diagram 400 of the processing of an interactive game in the form of a scratch card on a DVD, by a DVD player. The interactive game includes video sequences and virtual machine menus. The video sequences are used to define animations between states and animation as a result of interaction, and virtual-machine menus are used for interaction. The video sequences are stored in one or more video title sets (VTSs). A virtual machine menu is a sequence of DVD Virtual Machine commands defining navigation between the video sequences and other menus. The virtual machine menus are stored in the video manager group menu (VMGM), for example, or may be stored in any video title set menu (VTSM).

After a user couples the DVD with the DVD player, an initial view 405 is shown, for example on a TV screen connected to the DVD player. The initial view 405 comprises visual components in the form of scratch panels 410a, 410b, 410c and the initial view is a virtual-machine menu. The scratch panels 410a, 410b, 410c are similar to the scratch panels 105 of FIG. 1a-FIG. 1d.

Upon selection, by the user, of the scratch panel 410a, 410b, 410c a respective video title 415a, 415b, 415c is played. The video title 415a, 415b, 415c is a graphical representation of the scratching of the scratch panel 410a, 410b, 410c.

After the video title 415a, 415b, 415c has been played, a second virtual machine menu 420a, 420b, 420c is displayed to the user, the said second virtual machine menus 420a, 420b, 420c corresponding to the video titles 415a, 415b, 415c respectively.

At the second virtual machine menu 420a, 420b, 420c the user selects a second scratch panel 410a, 410b, 410c. Upon selection of the second scratch panel 410a, 410b, 410c, a second video title 425a, 425b, 425c, 425d, 425e, 425f is played. The second video title 425a, 425b, 425c, 425d, 425e, 425f is a graphical representation of the scratching of the second scratch panel 410a, 410b, 410c in the context of the second virtual machine menu 420a, 420b, 420c.

After playback of the second video title 425a, 425b, 425c, 425d, 425e, 425f a third virtual machine menu 430a, 430b, 430c is displayed to the user, the said third virtual machine menus 430a, 430b, 430c corresponding to the second video titles 425a, 425b, 425c, 425d, 425e, 425f. The second video title 425a, 425b, 425c, 425d, 425e, 425f is one of six alternatives, but the third virtual menu 430a, 430b, 430c is one of three alternatives. This is due to the second video file 425a, 425b, 425c, 425d, 425e, 425f displaying a transition from the second virtual menu 420a, 420b, 420c to the third virtual menu 430a, 430b, 430c, where the transition can happen in six ways, but using only three distinct menus.

Finally, at the third virtual menu 430a, 430b, 430c, the user has only a single scratch panel 410a, 410b, 410c to select. Upon selection, a third video title 435a, 435b, 435c is displayed, followed by a final common result video title 440. As is understood by one skilled in the art. the final common result video title 440 may be replaced by a final common result virtual machine menu.

The interactive game of chance includes a starting point, e.g. view 405, and an end point, e.g. video title 440. The starting point includes visual components of the interactive game. namely scratch panels 410a, 410b, 410c, and the end point includes the predetermined outcome.

One of a plurality of pathways between the starting point and the end point is traversed. The one pathway depends on interaction with the visual components.

In FIG. 4, the one pathway between the starting point and the end point is chosen without requiring a specific skill of the user, i.e. a user may randomly select an order in which to scratch the scratch panels 410a, 410b, 410c. As is understood by a person skilled in the art, the one pathway may be chosen in a skill dependent manner. For example, it may be faster for a skilled user to reach the predetermined outcome that an unskilled user.

In an alternative embodiment, in the context of poker, for example, a player may have cards available at a particular stage of the game and various bet options. For example, the player may choose to bet all money, half, or no money when committing to the next step of the game. If all money is bet, and the outcome is negative, the user immediately goes to the final outcome of the game. If, on the other hand, a portion of the users money is bet, game play is extended.

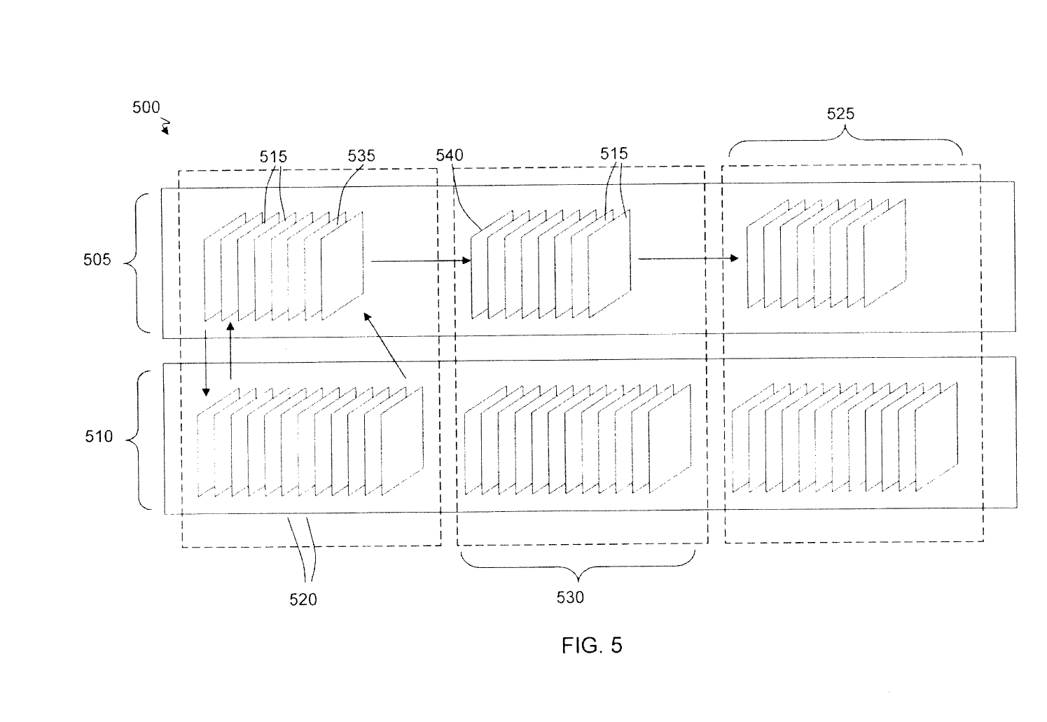

FIG. 5 shows a DVD structure 500 of a plurality of interactive games of chance stored on a single DVD.

The DVD structure includes a VMGM portion 505 and a VTS portion 510. The VMGM portion 505 includes a plurality of virtual machine menus 515 and the VTS portion 510 includes a plurality of titles 520. The plurality of virtual machine menus 515 comprises a plurality of virtual machine menu groups 525. The plurality of titles 520 comprises a plurality of title groups 530.

Each interactive game of chance is depicted with a broken box and comprises a virtual machine menu group 525 and a title group 530 similar to the structure described in FIG. 4. A virtual machine menu 515 of an interactive game of chance links to one or more titles, for example through an interactive component.

The plurality of interactive games of chance are linked via one or more menus of the virtual machine menus. A final menu of a first interactive game of chance 535 is linked to an initial menu of a second interactive game of chance 540 as is indicated by an arrow. As is understood by a person skilled in the art, the plurality of interactive games of chance may be linked through video titles, multiple video titlesets, including menus within video titlesets, or by other means.

As is understood by a person skilled in the art, only a small number of transitional arrows are indicated in FIG. 5, for the sake of clarity. Each menu and each video-title may link to one or more other menus and/or video titles in the same video titleset or span multiple video titlesets, or by other means.

The DVD may be replayed multiple times, but with the same outcome. This may be advantageous if a user wishes to experience a winning feeling again. A winning ticket may be given as a gift by a person knowing the winning outcome. Alternatively, losing tickets may be enjoyed again for the game only.

In alternative embodiments, a portable digital media may be single play. This may be performed by deleting, modifying or creating files on the portable digital media during play.

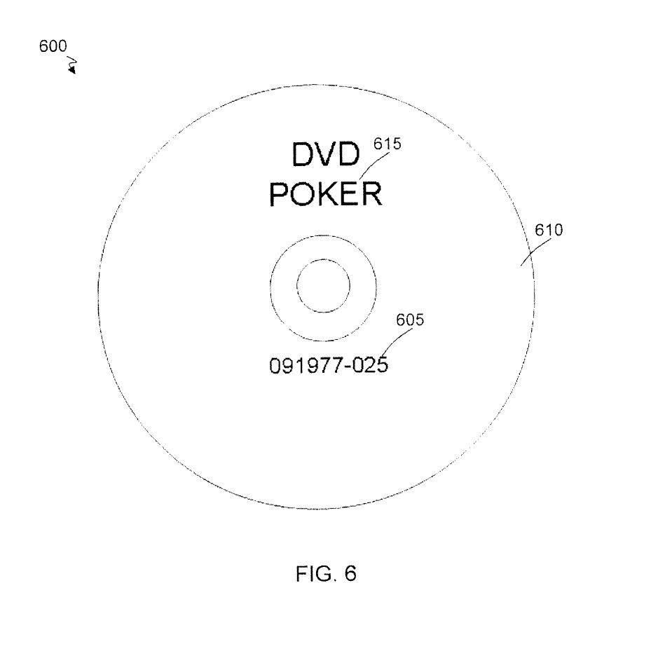

FIG. 6 shows a portable digital media 600 including an interactive game of chance according to an embodiment of the present invention. The interactive game of chance is an interactive game of chance of the type described in FIGS. 1-5, for example. The portable digital media 600 further includes a coded predetermined outcome 605 written on an outer surface 610 of the portable digital media 600.

The coded predetermined outcome 605 corresponds to a final outcome of the interactive game of chance. The final outcome of the interactive game of chance may be based upon a sequence of predetermined outcomes, or a single predetermined outcome. For example, a plurality of scratch cards 100 may be present on a portable digital media 600. In this case, the final outcome is a sum of individual outcomes of each of the plurality of scratch cards 100.

The coded predetermined outcome 605 is coded in a format that is not easily understandable by a user. The format may include encryption, or any other coding format as is understood by a person skilled in the art.

The portable digital media 600 may also include other information, including a brand identifier 615.

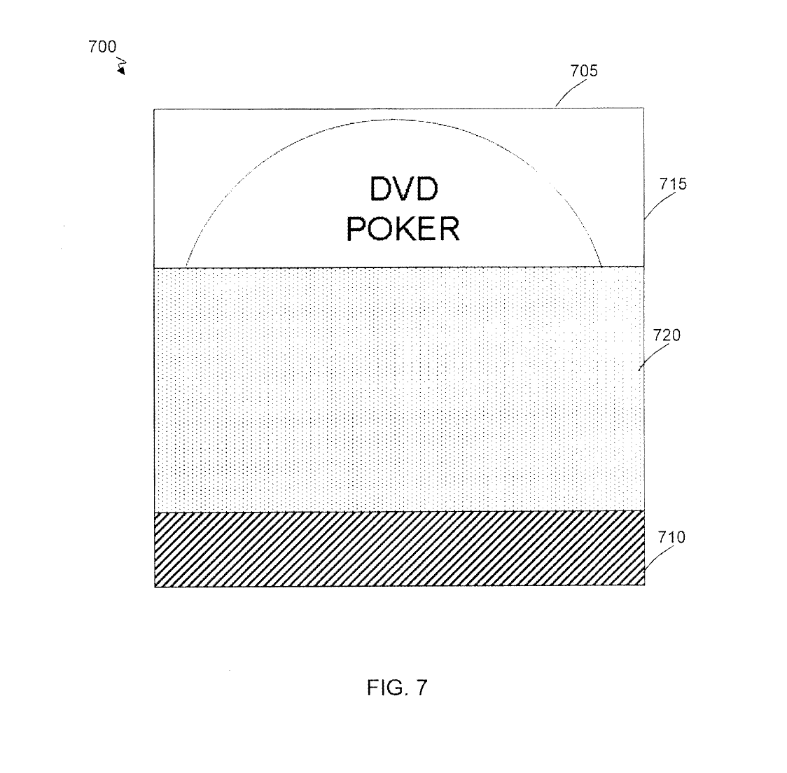

FIG. 7 shows a digital media 700, including a tamper resistant packaging 705, according to an embodiment of the present invention. The digital media may include a predetermined outcome, similar to the coded predetermined outcome 605 of FIG. 6, that is not visible through the tamper resistant packaging 705. The tamper resistant packaging 705 includes seals 710 which break upon opening, or any other type of resistance to tampering, such that the digital media 700 is difficult to remove or play, or the predetermined outcome is difficult to read, without visibly affecting the packaging.

The tamper resistant packaging includes a transparent component 715 and an opaque component 720. This enables portions of contents of the tamper resistant packaging to be seen, which may help with marketing, and portions of the contents to be hidden, which may help with security.

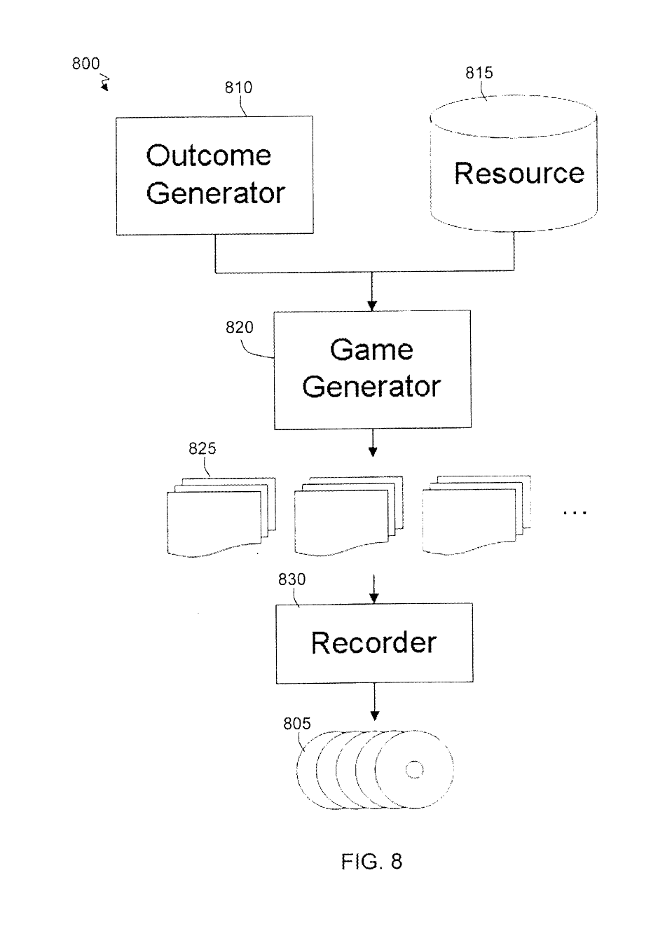

FIG. 8 illustrates a system 800 for generating digital media 805 including a game of chance according to an embodiment of the present invention.

The system includes an outcome generator 810 and a game resource 815. The outcome generator 810 and a game resource 815 are used as input to a game generator 820. The game generator 820 generates one or more data files 825 that together make a game of chance. The data files 825 may comprise MPEG files in a DVD suitable format, a combination of video and computer or consumer product instruction files, or any suitable format.

The system 800 further comprises a recorder 830. The recorder 830 takes the data files 825 and generates one or more digital media 805 including a game of chance. The recorder advantageously converts the data files to a format suitable for recording, for example an ISO Image including the ISO 9660 file system or the ISO/IEC 13346 file system, which is suited for burning to a DVD, a Compact Disc (CD) or a Blu-ray Disc (BD).

The system 800 may include the ability to batch process outcomes and games corresponding to a plurality of games on a single digital media 805, and/or corresponding to a plurality of digital media 805 having different outcomes, e.g. generating both winning digital media 805 and losing digital media 805.

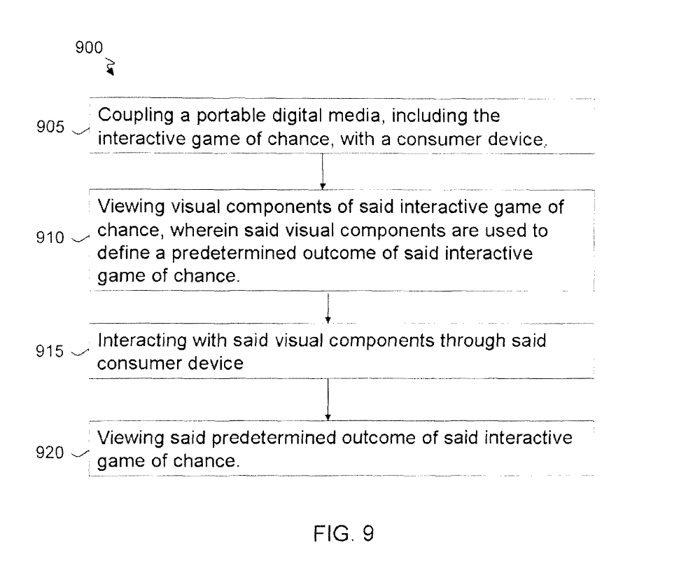

FIG. 9 shows a flow diagram 900 of a method of processing an interactive game of chance.

At step 905, a portable digital media, including the interactive game of chance, is coupled with a consumer device. The consumer device may be, for example, a DVD player or a personal computer.

At step 910, visual components of said interactive game of chance are viewed. The visual components are used to define a predetermined outcome of said interactive game of chance and may comprise reels of a slot machine and/or associated buttons, or panels of a virtual scratch card, for example.

At step 915, said visual components are interacted with through said consumer device. The interaction may be done through a remote control, a keyboard, a pointing device, or any other suitable input means.

At step 920, the predetermined outcome of the interactive game of chance is viewed. The predetermined outcome may be viewed through the visual components, or through a message associated with said visual components, for example.

In summary, advantages of some embodiments of the present invention include the ability to gamble at a time and place of choice, without needing a computer with an internet connection of a particular capability, without needing to register, without needing a credit card, and with the privacy of not allowing others to track gambling behaviour in great detail. Further, embodiments of the present invention include an interactive component that gives the user the feeling and excitement associated with gambling in real time and determining or changing a final outcome. Additionally, the portable digital media enables an enhanced multimedia experience including audio and visual effects, and an ability to have a long gaming session in a small format.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

The claims defining the invention are as follows:

1. A method of processing an interactive game of chance, including:
coupling a portable digital media, including said interactive game of chance, with a consumer device;
viewing visual components of said interactive game of chance, wherein said visual components are used to define a predetermined outcome of said interactive game of chance;
interacting with said visual components through said consumer device; and
viewing said predetermined outcome of said interactive game of chance.

2. The method of claim 1 further including redeeming a prize based upon said predetermined outcome.

3. The method of claim 1, wherein said interactive game of chance includes a virtual scratch card, said visual components include a plurality of scratch panels, and interacting with said visual components includes simulating scratching said plurality of scratch panels.

4. The method of claim 1, wherein said interactive game of chance includes a virtual slot machine, said visual components include reels of said virtual slot machine, and said step of interacting includes at least one of selecting a bet size, selecting a payline and initiating spinning of said reels.

5. The method of claim 1, wherein said interactive game of chance includes a virtual card game, said visual components include cards of said virtual card game, and said step of interacting includes at least one of selecting a bet size, and selecting cards to be held, discarded or drawn.

6. The method of claim 1, wherein said interactive game of chance includes a starting point including said visual components of said interactive game, and an end point including said predetermined outcome, wherein said interactive game comprises traversing one pathway of a plurality of pathways between said starting point and said end point, said one pathway dependent on said step of interacting with said visual components.

7. The method of claim 6, wherein said one pathway between said starting point and said end point is skill dependent.

8. The method of claim 1 further including selecting said interactive game from a plurality of interactive games, wherein said plurality of interactive games all include said predetermined outcome.

9. A portable digital media containing digital instructions, executable by a consumer device, for:
displaying visual components of an interactive game of chance, wherein said visual components are used to define an outcome of said interactive game of chance;
processing an interaction between a user and said visual components through said consumer device; and
displaying at least one predetermined outcome of said interactive game of chance, wherein said predetermined outcome is independent of said interaction.

10. The portable digital media of claim 9, wherein said predetermined outcome is associated with a prize.

11. The portable digital media of claim 9, further including a tamper resistant packaging.

12. The portable digital media of claim 9, wherein said predetermined outcome is written on an outer surface of said portable media.

13. The portable digital media of claim 12, wherein said predetermined outcome written on said outer surface is coded.

14. The portable digital media of claim 12, wherein said predetermined outcome written on said outer surface is not visible through a tamper resistant packaging.

15. The portable digital media of claim 9, wherein said portable digital media comprises a Digital Versatile Disc (DVD) and said digital instructions are recorded in video mode.

16. The portable digital media of claim 15, wherein said digital instructions comprise a virtual-machine menu and a plurality of video titles, wherein said interaction comprises selecting a component of said virtual-machine menu, and said digital instructions result in a display of a video title of said plurality of video titles based upon said component that was selected.

17. The portable digital media of claim 16, wherein said digital instructions comprise a first level virtual-machine menu, a plurality of second level virtual-machine menus, a plurality of first level video titles, and a plurality of second level video titles, wherein said interaction comprises selecting a first component of said first level virtual-machine menu and selecting a second component of a second level virtual-machine menu of said plurality of second level virtual-machine menus, wherein said digital instructions result in displaying a video of said plurality of first level video titles and said second level virtual-machine menu based upon said first component that was selected and displaying a video of said plurality of second level video titles based upon said second component that was selected.

18. The portable digital media of claim 9, wherein said portable digital media consists of one of the following: a USB memory, a DVD, a solid state memory device, a flash memory device, a memory stick, a smart media card, a secure digital card.

19. The portable digital media of claim 18, wherein said digital instructions comprise a computer program.

20. A system for generating a portable digital media including an interactive game of chance, including:
an outcome generator, which generates an outcome for an interactive game of chance;
an interactive game of chance resource including visual components;
a game generator, which generates said interactive game of chance from said interactive game of chance resource and said outcome, wherein said outcome is displayed using said visual component of said interactive game of chance resource; and
a game recorder, which records said interactive game of chance to a portable digital media.
